(19) United States
(12) Patent Application Publication
(10) Pub. No.: US 2005/0093495 A1
(43) Pub. Date: May 5, 2005

(54) Switch drive motor apparatus, magnetic disk apparatus, method of decreasing electromagnetic noise of switch drive motor apparatus, and method of decreasing electromagnetic noise of magnetic disk apparatus

(75) Inventors: Hiroaki Kobayashi, Kawasaki (JP); Hiroshi Oyabu, Kawasaki (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 10/973,234

(22) Filed: Oct. 26, 2004

(30) Foreign Application Priority Data
Oct. 31, 2003 (JP) 2003-372035
Oct. 18, 2004 (JP) 2004-303194

(51) Int. Cl. H02P 7/00

(52) U.S. Cl. 318/268

(57) ABSTRACT

A switch drive motor apparatus, includes: a switch drive motor which is rotatable by making a sequential switching; and a motor speed controller configured to drive the switch drive motor while varying a speed of the switch drive motor.

### CROSS-REFERENCE TO RELATED APPLICATIONS

This application is based upon and claims the benefits of the priority from the prior Japanese Patent Application Nos. 2003-372035, filed on Oct. 31, 2003 and 2004-303194, filed on Oct. 18, 2004 the entire contents of which are incorporated herein by reference.

### BACKGROUND OF THE INVENTION

1. Field of the Invention

The present invention relates to a switch drive motor apparatus preferable for a hard disk drive and the like, and a magnetic disk apparatus incorporating therein the switch drive motor apparatus. Moreover, the present invention relates to a method of decreasing an electromagnetic noise of a switch drive motor apparatus, and a method of decreasing an electromagnetic noise of the magnetic disk apparatus.

2. Description of the Related Art

Conventionally, a sound pressure level, an acoustic power level and the like are used as indexes of evaluating a noise of an electromagnetic disk apparatus and the like. Various proposals have been made for decreasing the noise evaluated by the above indexes. More specifically, various proposals have been made for decreasing a switching noise which may be caused in a driving of a spindle motor of the above magnetic disk apparatus and the like, as is disclosed, for example, in Japanese Patent Application Laid-Open (JP-A) No. 7-337073, JP-A No. 2002-10678 and JP-A No. 2002-209395. With an advanced performance of the magnetic disk apparatus, noises such as the switching noise including those of the sound pressure level, the acoustic power level and the like described above have been decreased as a whole. Instead, an electromagnetic noise which is an uncomfortable noise and was not felt conventionally has come to be audible.

The uncomfortable noise is attributable to an electromagnetic noise caused when a switching noise made through a switching of phases for rotatably driving a motor (such as a spindle motor and the like in a magnetic disk apparatus and the like) is superimposed with a coil voltage. Conventionally, changing and the like of the structure of the motor itself were tried for decreasing the above uncomfortable noise, resulting in failure in obtaining an effect. Moreover, the above changing and the like may increase cost and cause harmful effect on property of the magnetic disk and the like. In sum, a technology is yet to be proposed for effectively controlling and decreasing the uncomfortable noise attributable to the electromagnetic noise.

Objects and Advantages

It is an object of the present invention to accomplish the following, by solving the above issues in the conventional technology.

It is an object of the present invention to provide a switch drive motor apparatus and a high-performance magnetic disk apparatus incorporating therein the switch drive motor which apparatuses can effectively control and decrease a prominent discrete tone which is uncomfortable and is attributable to an electromagnetic noise caused when a switching noise made through a switching of phases for rotatably driving a motor (such as a spindle motor and the like of a hard disk drive and the like) is superimposed with a coil voltage.

Moreover, it is another object of the present invention to provide a method of decreasing an electromagnetic noise of a switch drive motor apparatus and a method of decreasing an electromagnetic noise of the magnetic disk apparatus which methods can effectively control and decrease the prominent discrete tone which is uncomfortable and is attributable to the above electromagnetic noise.

### SUMMARY OF THE INVENTION

The present invention is based on a concept of the present inventors, which concept can be specifically described as follows. Concept: An uncomfortable noise may be felt when, in a discrete tone which is a sharp peak element arising on the spectrum, a prominent discrete tone having a peak that is more than other frequency elements (which are in the vicinity of the prominent discrete tone) by a predetermined threshold or more is present. Varying a speed of the motor (such as a spindle motor and the like in a magnetic disk apparatus and the like), however, can effectively control and decrease the prominent discrete tone which is uncomfortable and is attributable to an electromagnetic noise.

A switch drive motor apparatus of the present invention, comprises: a switch drive motor which is rotatable by making a sequential switching; and a motor speed controller configured to drive the switch drive motor while varying a speed of the switch drive motor.

Like a multi-phase and multi-pole (for example, three phases and twelve poles) motor, the above switch drive motor of the present invention is rotatable by making sequential switchings of energizing. In this case, however, the switch drive motor having a constant speed may cause a noise which is uncomfortable and is attributable to the electromagnetic noise. The analysis of the noise has found that, in a discrete tone which is a sharp peak element arising on the spectrum, a prominent discrete tone having a peak that is more than other frequency elements (which are in the vicinity of the prominent discrete tone) by a predetermined threshold or more is present. With the above switch drive motor apparatus of the present invention, however, the motor speed controller may drive the switch drive motor while varying the speed of the switch drive motor, thus effectively controlling and decreasing the prominent discrete tone which is uncomfortable and is attributable to the electromagnetic noise. The switch drive motor apparatus can eliminate the need of a special design change (for preventing the prominent discrete tone) in the structure, causing less influence on the apparatus's property.

A magnetic disk apparatus of the present invention comprises a switch drive motor apparatus.

The magnetic disk apparatus comprises the switch drive motor apparatus of the present invention. In this case, the switch drive motor in the switch drive motor apparatus having a constant speed may cause a noise which is uncomfortable and is attributable to the electromagnetic noise. A motor speed controller in the switch drive motor apparatus, however, may drive the switch drive motor while varying a speed of the switch drive motor, thus effectively controlling and decreasing the prominent discrete tone which is uncomfortable and is attributable to the electromagnetic noise. The magnetic disk apparatus can eliminate the need of a special design change (for preventing the prominent discrete tone) in the structure, causing less influence on the apparatus's property.

A method of decreasing an electromagnetic noise of a switch drive motor apparatus of the present invention comprises: driving the switch drive motor while varying a speed in the switch drive motor apparatus which is rotatable by making a sequential switching.

The method of decreasing the electromagnetic noise of the switch drive motor apparatus comprising the driving of the switch drive motor while varying the speed in the switch drive motor apparatus can effectively control and decrease the prominent discrete tone which is uncomfortable and is attributable to the electromagnetic noise.

In a method of decreasing an electromagnetic noise of a magnetic disk apparatus of the present invention, the magnetic disk apparatus has a switch drive motor apparatus. The method of decreasing the electromagnetic noise of the magnetic disk apparatus includes the method of decreasing the electromagnetic noise of the switch drive motor apparatus.

The method of decreasing the electromagnetic noise of the magnetic disk apparatus which includes the method of decreasing the electromagnetic noise of the switch drive motor and comprises the driving of the switch drive motor while varying a speed in the switch drive motor apparatus can effectively control and decrease the prominent discrete tone which is uncomfortable and is attributable to the electromagnetic noise.

### BRIEF DESCRIPTION OF THE DRAWINGS

FIG. 1 is a schematic of an example of a magnetic disk apparatus of the present invention, which apparatus is provided, as a spindle motor, with a switch drive motor apparatus of the present invention.

FIG. 2 is an example of a chart showing a result of measurement of a discrete tone of the magnetic disk apparatus, with a magnetic disk speed of 4,200 rpm, in a state where a speed of the spindle motor is not varied.

FIG. 3 is a partly enlarged view of the chart in FIG. 2, showing a peak (vicinity thereof) of a secondary switching element with a range of 4 kHz to 6 kHz enlarged.

FIG. 4 is similar to FIG. 3 but showing a state where the speed of the spindle motor is continuously varied.

FIG. 5 is a graph showing a change in a sound pressure level (dB) when the speed of the magnetic disk in the magnetic disk apparatus is changed (increased) stepwise by 1 rpm based on 4,200 rpm.

FIG. 6 is a graph showing a change in tone-to-noise ratio (TNR) (dB) when the speed of the magnetic disk in the magnetic disk apparatus is changed (increased) stepwise by 1 rpm based on 4,200 rpm.

FIG. 7 is a graph showing a change in sound pressure level (dB) when the speed of the magnetic disk in the magnetic disk apparatus is changed (increased) stepwise by 1 rpm based on 5,400 rpm.

FIG. 8 is a graph showing a change in tone-to-noise ratio (TNR) (dB) when the speed of the magnetic disk in the magnetic disk apparatus is changed (increased) stepwise by 1 rpm based on 5,400 rpm.

### DESCRIPTION OF THE PREFERRED EMBODIMENTS

(Switch drive motor apparatus, and method of decreasing electromagnetic noise of switch drive motor) A switch drive motor apparatus of the present invention includes a switch drive motor which is rotatable by making a sequential switching; and a motor speed controller configured to drive the switch drive motor while varying a speed of the switch drive motor. Moreover, the switch drive motor apparatus of the present invention includes other apparatus(es) and the like properly selected according to an object.

A method of decreasing an electromagnetic noise of the switch drive motor apparatus of the present invention includes driving the switch drive motor while varying a speed of the switch drive motor, and further includes other treatment(s) that is properly selected according to the object or necessity. In the method of decreasing the electromagnetic noise of the switch drive motor, it is preferable to drive the switch drive motor while varying the speed of the switch drive motor with the motor speed controller.

As long as being capable of being rotatably driven by the sequential switching, the switch drive motor is not specifically limited, and can be properly selected from those known in the art, examples thereof including an AC (alternating current) motor and a DC (direct current) motor, and specific examples including an electromagnetic force motor and the like.

The electromagnetic force motor is not specifically limited, and can be properly selected according to the object, examples thereof including a commutator motor, a rotary magnetic field motor, a vibratory motor and the like, which may be used alone or in combination of two or more.

The commutator motor is not specifically limited, and can be properly selected according to the object, examples thereof including: a DC motor such as an electromagnetic field motor, a permanent magnetic field motor and the like; a universal motor (for both AC and DC) such as a single-phase series-wound motor, and the like; and the like.

The rotary magnetic field motor is not specifically limited, and can be properly selected according to the object, examples thereof including: a reluctance rotor motor such as a reluctance synchronous motor (reaction motor), a VR (voltage regulator, voltage relay) stepping motor and the like; a DC brushless motor (self-excitation); a PM (pulse modulation) stepping motor; an HB (half breadth) stepping motor; a timing motor (inductor synchronous motor); a permanent magnet rotor motor such as a permanent magnet synchronous motor (separate excitation); an induction motor (reversible motor) such as a shaded pole motor and the like; a hysteresis motor (hysteresis synchronous motor); and the like.

The vibratory motor is not specifically limited, and can be properly selected according to the object, examples thereof including a voice coil motor, a vibro motor, and the like.

Of the present invention, preferable examples of the switch drive motor include a spindle motor for rotatably driving a magnetic disk, a CD (compact disk), an FD (flexible disk) and the like; a carriage motor; a tracking motor; and the like.

Among the above, the spindle motor is preferable, from the view point of controlling and decreasing a prominent discrete tone which is uncomfortable and is attributable to the electromagnetic noise. The spindle motor is especially preferable for use as a magnetic disk apparatuses such as a hard disk and the like.

Examples the type of the spindle motor include an AC motor, a DC brushless motor, and the like. Preferable examples of the structure of the spindle motor include an in-hub, a bottom and the like. Among the above spindle motors, those having a plurality of phases and a plurality of poles are preferable, especially preferable is the one having three phases and twelve poles. Moreover, the one driven by bipolar is preferable.

The speed of the switch drive motor is not specifically limited, and can be properly selected according to the object. The switch drive motor used for the magnetic disk apparatus and the like is preferred to have the speed of 4,000 rpm or more, specifically, 4,200 rpm, 5,400 rpm and the like.

The system of rotatably driving the switch drive motor is not specifically limited, and can be properly selected according to the object, examples thereof including a direct drive system, a belt drive system, a gear drive system, and the like.

As long as being capable of driving the switch drive motor while varying the speed of the switch drive motor, the motor speed controller is not specifically limited, and can be properly selected according to the object, examples thereof including an open loop controlling system. In view of easiness of stabilizing the speed by sensing a variation in the speed and then controlling a power supplied to the switch drive motor according to the above speed variation, however, other preferable examples thereof may include a closed loop controlling system, a feedback controlling system and the like each of which is provided with at least one of a power transistor and a servo circuit. Hereinabove, the servo motor is, in general, defined to have a controlling mechanism by the above controlling systems. The switch drive motor apparatus of the present invention may be designed as the servo motor.

The system of controlling the speed with the motor speed controller is not specifically limited, and can be properly selected according to the object from those known in the art, examples thereof including a bridge servo, a proportional current control, DC tacho+voltage comparison control, AC tacho+voltage comparison control, an FG (F/V)+voltage comparison control, frequency synchronous control, a PLL (phase lock loop) control, and the like. Hereinabove, the FG stands for filament ground and the F/V stands for frequency to voltage.

The system of controlling the power with the motor speed controller is not specifically limited, and can be properly selected according to the object from those known in the art, examples thereof including a PWM (pulse width modulation) control (PAM (pulse amplitude modulation) control), a vector control, a pulse control, a bipolar control, a pedestal control, a resistance control, and the like. In addition, a micro step control, an inverter control, a multi-phase drive, a switching control, and the like are also included in the examples. Among the above, the vector control, the pulse control, the multi-phase control, and the switching control and the like are preferable, from the view point of controlling and decreasing the prominent discrete tone which is uncomfortable and is attributable to the electromagnetic noise.

Of the present invention, the motor speed controller is in need of being capable of driving the switch drive motor while varying the speed of the switch drive motor, thus effectively controlling and decreasing the prominent discrete tone which is uncomfortable and is attributable to the electromagnetic noise.

As long as being capable of controlling and decreasing the prominent discrete tone which is uncomfortable and is attributable to the electromagnetic noise, the system of varying the speed of the switch drive motor is not specifically limited, and can be properly selected according to the object, examples thereof including a stepwise (discontinuous) variation per a minute time and a continuous variation, the latter being more preferable.

The variation width (variation degree) of varying the switch drive motor with the motor speed controller is not specifically limited, and can be properly selected according to the object, examples thereof including 3 rpm or more, more preferably 8 rpm or more.

In the case that the switch drive motor apparatus is used for the magnetic disk apparatus and the like, the following switchings are preferable: i) with a recording head (magnetic head) of the magnetic disk apparatus not present on the magnetic disk, the motor speed controller may vary the speed of the switch drive motor with a variation width of 3 rpm or more, and ii) with the recording head (magnetic head) of the magnetic disk apparatus present on the magnetic disk, the motor speed controller is substantially free from varying the speed of the switch drive motor. The above is advantageous in that the effective controlling and decreasing of the prominent discrete tone (which is uncomfortable and is attributable to the electromagnetic noise) is accomplished in so-called an idling state and in that no harmful effect is caused to the apparatus's property.

The method of measuring the discrete tone caused by the switch drive motor apparatus of the present invention is not specifically limited, and can be properly selected according to the object, examples thereof including an FFT (fast Fourier transform) analyzer, a frequency analyzer, and the like.

The method (medium) of quantifying a peak sharpness (scale) of the discrete tone is not specifically limited, and can be properly selected according to the object, examples thereof including a tone-to-noise ratio (TNR), a prominence ratio (PR), and the like.

In Annex D (1999-Aug.-01) of ISO (International Organization for Standardization) 7779, the tone-to-noise ratio (TNR) is specified as an identification of prominent discrete tone. The above Annex describes a method of determining whether or not the prominent discrete tone is contained in the noise caused. The above Annex is mainly applied to an apparatus operated by an operator, and may also be applied to an apparatus which is located in a low noise zone. The discrete tone that may occur substantially simultaneously with a wide band noise can be masked, to a certain extent, with a masking noise of the wide band noise. Hereinabove, the masking noise is present in a frequency band having a relatively narrow width, with a discrete tone (that is referred to as a critical band) centered at the frequency band. A noise out of the critical band does not make so great a contribution to the masking of the discrete tone. The width of the critical band is a function of the frequency. In general, a sound is narrowly audible (threshold of audibility) when having its pressure about 4 dB lower than a pressure of the noise that is present within the critical band around (the frequency of) the sound.

The tone-to-noise ratio (TNR) ΔL (dB) can be obtained from Lₜ−Lₙ, where Lₜ denotes the sound pressure level (dB) of the discrete tone and Lₙ denotes the sound pressure level (dB) of the masking noise. A critical band width Δfc at a predetermined frequency can be obtained by the following expression: Δfc=25.0+75.0 (1.0+1.4 (f/1000)²)^{0.69}.

For example, f=1 kHz makes Δfc=162.2 Hz. In the above Annex (1999-Aug.-01) of ISO (International Organization for Standardization) 7779, a sound pressure at a predetermined discrete tone which pressure is, 6 dB more than a sound pressure of the noise in the critical band may be determined as a prominent discrete tone. In other words, a predetermined discrete tone meeting the following expression and is audible in a listening test may be determined as the prominent discrete tone:
Expression (Lₜ−Lₙ)>6.0 dB.

The discrete tone can be measured in the operator's position of the apparatus when the operator's position is determined. For a plurality of the operator's positions (namely, position is not determined), on the contrary, the position having the highest sound pressure (A character) level (tone level) may be selected for the measurement. In the case of the apparatus free from the operator's position, however, the following bystander position 1 and bystander position 2 may be selected:

Bystander Position 1:

On a horizontal face which is 1.50 m±0.03 m high from a floor, the bystander position 1 is defined as the position having the highest sound pressure (A character) level, the bystander position 1 being selected from an aggregate of dots which are 1.00 m±0.03 m from a sound source.

Bystander Position 2:

The bystander position 2 is defined, on the above horizontal face, as all other positions than the bystander position 1. Herein, the bystander position 2 has, however, a sound pressure level difference from the bystander position 1 by 0.5 dB or less.

For parts to be built in a desk apparatus, the measurement of the discrete tone can be carried out in the following manner: Put the parts on a standard test bench by mounting 3 to 4 rubber legs to the parts such that the parts can be about 12 mm spaced apart from an upper face of the standard test bench. For a desk apparatus defining an operator's position, such position can be used for the measurement, while a desk apparatus not defining the operator's position, the above bystander position 1 and bystander position 2 can be used.

The discrete tone of the switch drive motor apparatus and the discrete tone of the magnetic disk apparatus incorporating therein the switch drive motor apparatus are each an electromagnetic noise (switching sound) attributable to a switching noise made mainly through switching of phases of the switch drive motor. A noise frequency analysis can ordinarily sense a primary switching element to a tertiary switching element of the switching sound. Of the present invention, effectively decreasing the switching element (primary to tertiary) can eliminate the need of design change and the like in a structure of the switch drive motor itself, thereby effectively controlling and decreasing the prominent discrete tone (which is uncomfortable and is attributable to the electromagnetic noise), without incurring a special cost for the effective decreasing of the switching element and without causing a harmful effect on the apparatus's property. Of the present invention, even when the tone-to-noise ratio (TNR) specified in ISO 7779 (1999-Aug.-01) is 6 dB or more before the varying of the speed, the motor speed controller varying the speed of the switch drive motor can decrease the tone-to-noise ratio (TNR) to 6 dB or less without substantially increasing the sound pressure, resulting in effective controlling and decreasing of the prominent discrete tone which is uncomfortable and is attributable to the electromagnetic noise.

The switch drive motor apparatus of the present invention can effectively control and decrease the prominent discrete tone which is uncomfortable and is attributable to the electromagnetic noise caused when a switching noise made through the switching of the phases for rotatably driving the motor (such as the spindle motor and the like of the hard disk drive and the like) is superimposed with a coil voltage. With this, the switch drive motor apparatus of the present invention can be preferably used as a motor such as the spindle motor and the like of the disk apparatuses including various magnetic disk apparatuses and various optical disk apparatuses. Hereinabove, the various magnetic disk apparatuses and the various optical disk apparatuses include a hard disk drive, a CD (compact disk) apparatus, an MD (mini disk) apparatus, an FD (flexible disk) apparatus, a DVD (digital video disk, digital versatile disk) apparatus, and the like.

The method of decreasing the electromagnetic noise of the switch drive motor apparatus of the present invention can effectively control and decrease the prominent discrete tone which is uncomfortable and is attributable to the electromagnetic noise. With this, the method of decreasing the electromagnetic noise of the switch drive motor apparatus of the present invention is preferable for effectively controlling and decreasing the prominent discrete tone which is uncomfortable and is attributable to the electromagnetic noise caused when a switching noise made through the switching of the phases for rotatably driving the motor (such as the spindle motor and the like of the disk apparatuses including various magnetic disk apparatuses and various optical disk apparatuses) is superimposed with a coil voltage. Hereinabove, the various magnetic disk apparatuses and the various optical disk apparatuses include a hard disk drive, a CD (compact disk) apparatus, an MD (mini disk) apparatus, an FD (flexible disk) apparatus, a DVD (digital video disk, digital versatile disk) apparatus, and the like.

(Magnetic Disk Apparatus, and Method of Decreasing Electromagnetic Noise of Magnetic Disk Apparatus)

As long as having the above switch drive motor apparatus of the present invention, the magnetic disk apparatus of the present invention is not specifically limited, can be properly selected in terms of structure according to the object from those known in the art, and can have other apparatuses and the like properly selected from those known in the art.

Of the present invention, the method of decreasing the electromagnetic noise of the magnetic disk apparatus is a method of decreasing the electromagnetic noise of the magnetic disk apparatus that has the switch drive motor apparatus. As long as including the method of decreasing the electromagnetic noise of the switch drive motor apparatus, the method of decreasing the electromagnetic noise of the magnetic disk apparatus is not specifically limited, and can have other treatment and the like properly selected, when necessary, according to the object. In the case of the method of decreasing the electromagnetic noise of the magnetic disk apparatus, it is preferable to drive the switch drive motor apparatus while varying the speed of the switch drive motor with the motor speed controller.

The magnetic disk apparatus and the method of decreasing the electromagnetic noise of the magnetic disk apparatus of the present invention have the above switch drive motor apparatus of the present invention. The switch drive motor of the switch drive motor apparatus has a plurality of phases. A switching noise made through the switching of a transistor for switching the plurality of the phases in the driving of the switch drive motor may cause the electromagnetic noise, with the switching noise superimposed with the coil voltage. Even though the electromagnetic noise naturally includes the above prominent discrete tone, the motor speed controller in the switch drive motor apparatus can drive the switch drive motor while varying the speed of the switch drive motor, thus actually eliminating the prominent discrete tone, resulting in effective controlling and decreasing of the prominent discrete tone which is uncomfortable and is attributable to the electromagnetic noise.

Like the description of the switch drive motor apparatus and the method of decreasing the electromagnetic noise of the switch drive motor apparatus, the magnetic disk apparatus and the method of decreasing the electromagnetic noise of the magnetic disk apparatus can take the following preferable operations for preventing a possible harmful effect on the apparatus's property which effect may be caused while varying the speed of the switch drive motor:

Operation 1: When an actuator is withdrawn to a ramp, the speed of the spindle motor as the switch drive motor is to be varied.

Operation 2: When the actuator is operated on a medium (magnetic disk), the speed of the spindle motor as the switch drive motor is not to be varied.

The magnetic disk apparatus of the present invention may be designed as a hard disk assembly having the above switch drive motor as a spindle motor and having a magnetic disk and the like. In addition, instead of the above assembly apparatus, the magnetic disk apparatus of the present invention may be designed as a complete magnetic disk apparatus like a hard disk drive.

Hereinabove, the hard disk assembly may have a voice coil motor, a head actuator and the like.

Examples of other apparatuses of the magnetic disk apparatus include a magnetic disk, a recording head (a magnetic head), a carriage arm, a shaft pivotally support the carriage arm, an actuator for turning the carriage arm, a part for withdrawing the magnetic head, a housing (such as a base, a cover, and the like) for housing therein the above described, and the like.

The magnetic head is not specifically limited, and can be properly selected according to the object, examples thereof including a horizontal magnetic recording head, a vertical magnetic recording head and the like. Among the above, the vertical magnetic recording head is preferred. The vertical magnetic recording head is not specifically limited, and can be properly selected according to the object, examples thereof including a single magnetic pole head and the like. The vertical magnetic recording head may be for writing only, otherwise may be a unity with a reading head (such as a GMR (ground mapping radar) and the like) for writing and reading.

The system of starting the magnetic head of the magnetic disk apparatus is not specifically limited, and can be properly selected according to the object, an especially preferable example thereof including the following:

Contact start stop (CSS): when the magnetic disk is making a stop, the magnetic head can contact the magnetic disk, thus starting rotation of the magnetic disk with the magnetic head floated.

With the above contact start stop (CSS), it is preferable that the magnetic head contacts a zone (CSS zone) other than a zone where the data of the above magnetic disk is written.

Capacity, speed, scale and the like of the magnetic disk are not specifically limited, and can be properly selected according to the object, examples thereof including: 20 GB, 30 GB, 40 GB, 50 GB, 60 GB and 80 GB and the like for the capacity; 4200 rpm, 5400 rpm and the like for the speed; and 2.5 inch and the like for the scale.

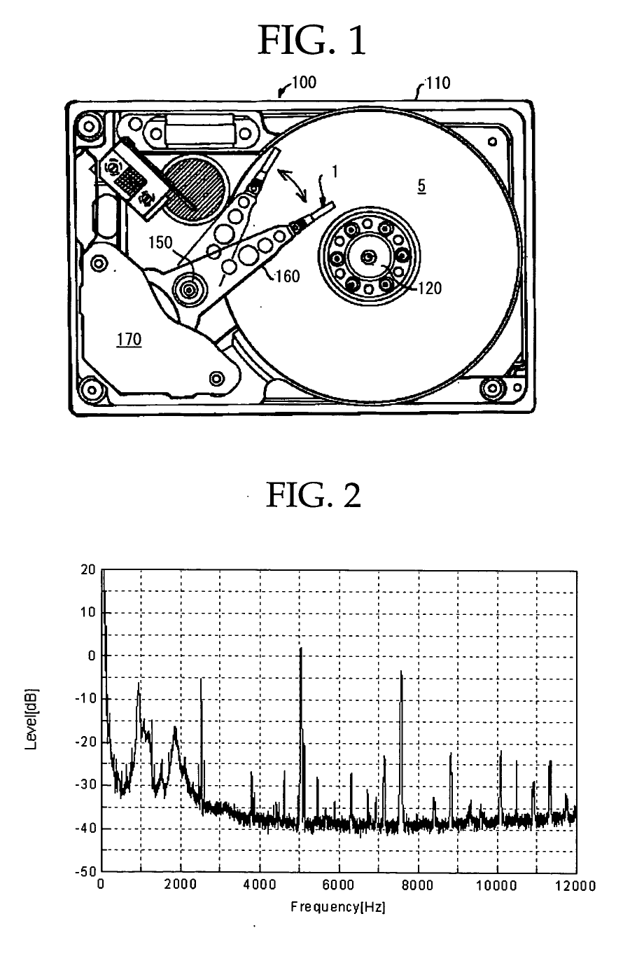

Hereinafter described referring to FIG. 1 is an example of the magnetic disk apparatus of the present invention. A magnetic disk apparatus 100 in FIG. 1 has a housing 110 in which a magnetic disk 5, a spindle motor 120, a head slider 1, a shaft 150, a carriage arm 160 and an actuator 170 are housed. The spindle motor 120 is the switch drive motor apparatus of the present invention. Operating the magnetic disk apparatus 100 may carry out the method of decreasing the electromagnetic noise of the switch drive motor and the method of decreasing the electromagnetic noise of the magnetic disk apparatus, of the present invention.

With the magnetic disk apparatus 100, the spindle motor 120 can rotate the magnetic disk 5 in the recording and the like. The head slider 1 is pivotally supported by the shaft 150 and is mounted to an end of the carriage arm 160 which is pivoted by the actuator 170.

In the magnetic disk apparatus 100, the spindle motor 120 may turn the magnetic disk 5 in the recording and the reading of the information. On the other hand, the head slider 1 withdrawn from an upper portion of the magnetic disk 5 may be moved to the innermost peripheral side of a recording face of the magnetic disk 5 thus turned, with the carriage arm 160 turned around the shaft 150 by the actuator 170.

The head slider 1 may be sequentially moved from the innermost peripheral side to the outermost peripheral side on the magnetic disk 5 by means of the actuator 170, to thereby carry out the recording (writing) and the reading of the information in the magnetic disk 5. After completion of the recording (writing) and the reading of the information, the head slider 1 may be withdrawn from the upper portion of the magnetic disk 5 (for example, withdrawn to a ramp (not shown)). Then, the spindle motor 120 in an idling state may be continuously varied in its speed, thus effectively controlling and decreasing the prominent discrete tone which is uncomfortable and is attributable to the electromagnetic noise. After completion of operation when keeping of the idling state is not necessary, the rotation of the spindle motor 120 may be stopped, thus stopping the rotation of the magnetic disk 5.

The magnetic disk apparatus of the present invention has such a high performance as to effectively control and decrease the prominent discrete tone which is uncomfortable and is attributable to the electromagnetic noise caused when a switching noise made through the switching of the phases for rotatably driving the motor (such as the spindle motor and the like of the hard disk drive and the like) is superimposed with a coil voltage. With this, the magnetic disk apparatus of the present invention can be preferably used as a hard disk drive, an FD (flexible disk) apparatus and the like.

The method of decreasing the electromagnetic noise of the magnetic disk apparatus of the present invention can effectively control and decrease the prominent discrete tone which is uncomfortable and is attributable to the electromagnetic noise. With this, the method of decreasing the electromagnetic noise of the magnetic disk apparatus of the present invention can effectively control and decrease the prominent discrete tone which is uncomfortable and is attributable to the electromagnetic noise caused when a switching noise made through the switching of the phases for rotatably driving the motor (such as the spindle motor and the like of the magnetic disk apparatus and the like including a hard disk drive, an FD (flexible disk) apparatus and the like) is superimposed with a coil voltage.

Hereinafter described is an embodiment of the present invention. The present invention is, however, not limited to the embodiment.

A magnetic disk apparatus having a speed of a magnetic disk of 4,200 rpm is used. A spindle motor having three phases and twelve poles (bipolar drive) is used as the switch drive motor of the present invention. The spindle motor is provided with a motor speed controller that can arbitrarily vary the speed of the spindle motor. A switching frequency of the switch drive motor can be calculated based on 3 (phases)×12 (poles)×rotary frequency. The speed 4,200 rpm of the magnetic disk in the magnetic disk apparatus can bring about the rotary frequency of 70 Hz, with the switching frequency of 2,520 Hz (primary switching element), 5,040 Hz (secondary switching element) and 7,560 Hz (tertiary switching element). FIG. 2 shows an example of a chart after measuring, with an FFT (fast Fourier transform) analyzer, the discrete tone in a state where the speed of the spindle motor is not varied. The chart evidently shows that the primary switching element is in the vicinity of 2,520 Hz, the secondary switching element is in the vicinity of 5,040 Hz, and the tertiary switching element is in the vicinity of 7,560 Hz.

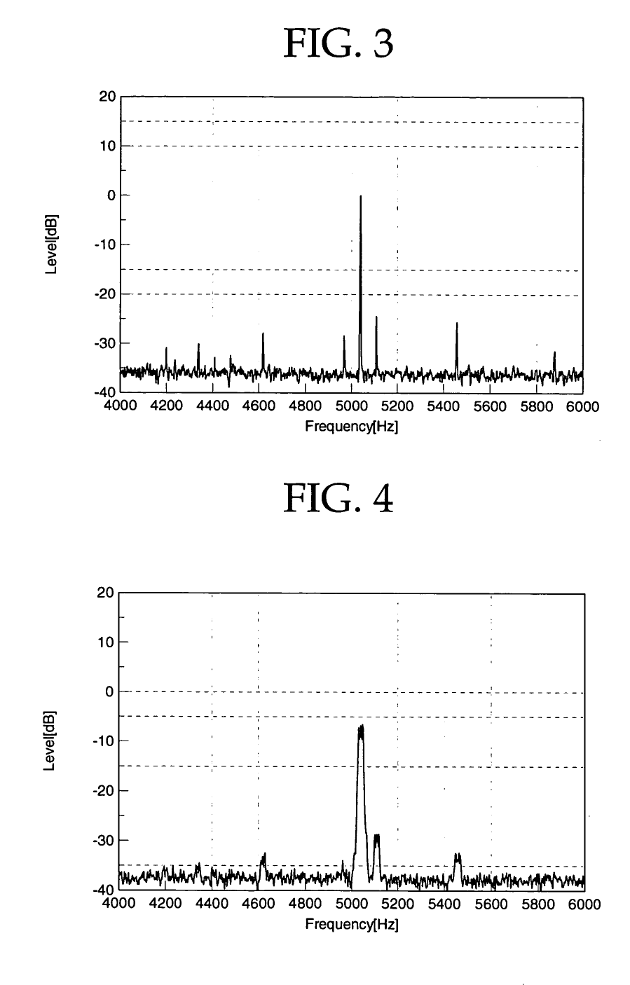

FIG. 3 is a partly enlarged view of the chart in FIG. 2, enlarging the range of 4 kHz to 6 kHz, namely in the vicinity of a peak of the secondary switching element. In FIG. 3, the speed of the spindle motor is not varied. FIG. 4 is similar to FIG. 3 but showing a state where the speed of the spindle motor is continuously varied by means of the motor speed controller.

The chart in FIG. 3 where the speed of the spindle motor is not varied shows the peak level=0 dB and the tone-to-noise ratio TNR=11.4 dB. The tone-to-noise ratio TNR having the threshold of 6 dB as described above signifies that, at 11.4 dB, the prominent discrete tone is present which is uncomfortable and is attributable to the electromagnetic noise. In this case, therefore, the prominent discrete tone is caused which is uncomfortable and is attributable to the electromagnetic noise.

On the other hand, the chart in FIG. 4 where the speed of the spindle motor is continuously varied by means of the motor speed controller shows the peak level=−6.4 dB and the tone-to-noise ratio TNR=0.4 dB.

The tone-to-noise ratio TNR prominently decreased to 0.4 dB can be described as follows:

The critical band width Δfc at the peak (5,040 Hz) of the secondary switching element can be obtained by the following expression: Δfc=25.0+75.0 (1.0+1.4 (5,040/1000)2)^{0.69}. With the above critical band width Δfc, the height 1 (scale) at the peak (5,040 Hz) of the secondary switching element may be decreased relative to the height 2 (scale) of the peak other than the peak (5,040 Hz) of the of the secondary switching element, thus decreasing the height 2 relative to the height 1. As a result, the tone-to-noise ratio (TNR) ΔL (dB) obtained from the above Lₜ−Lₙ is prominently decreased to 0.4 dB. The tone-to-noise ratio TNR having the threshold of 6 dB as described above signifies, in this case, that no prominent discrete tone is present. As a result, in this case, the prominent discrete tone is not caused, thus effectively controlling and decreasing the prominent discrete tone which is uncomfortable and is attributable to the electromagnetic noise.

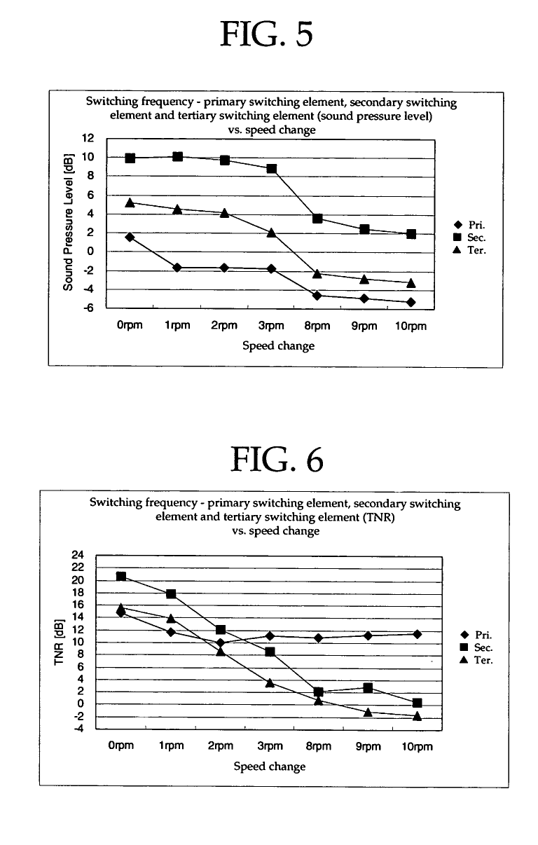

FIG. 5 is a graph showing a change in a sound pressure level (dB) when the speed of the spindle motor (or the magnetic disk connected to the spindle motor) of the magnetic disk apparatus is changed (increased) stepwise by ±1 rpm based on 4,200 rpm. FIG. 6 is a graph showing a change in the tone-to-noise ratio (TNR) (dB) when the speed of the spindle motor (or the magnetic disk connected to the spindle motor) of the magnetic disk apparatus is changed (increased) stepwise by ±1 rpm based on 4,200 rpm. Herein, the speeds of 1 rpm to 10 rpm on the abscissa of the graphs in FIG. 5 and FIG. 6 respectively denote ±1 rpm to ±10 rpm.

FIG. 6 evidently shows that varying the speed of the spindle motor (speed of the magnetic disk) may decrease the tone-to-noise ratio (TNR) of each of the primary switching element, the secondary switching element and the tertiary switching element. In this case, the speed of the spindle motor of 4,200 rpm, that is, “0 rpm” on the abscissa in FIG. 6, may allow the switching element with the highest tone-to-noise ratio (TNR) to become a main element of the uncomfortable noise. In FIG. 6, it is the secondary switching element that is the main element of the uncomfortable noise. Varying the speed of the spindle motor by ±3 rpm or more may effectively decrease the tone-to-noise ratio (TNR), and varying the speed of the spindle motor by ±8 rpm or more may prominently decrease the tone-to-noise ratio (TNR). On the abscissa in FIG. 6, the decrease in the tone-to-noise ratio (TNR) to less than when it is at the “0 rpm” may signify that the decreasing of the uncomfortable noise is effected. The more the uncomfortable noise is decreased in amount, the more prominently the decreasing is effected.

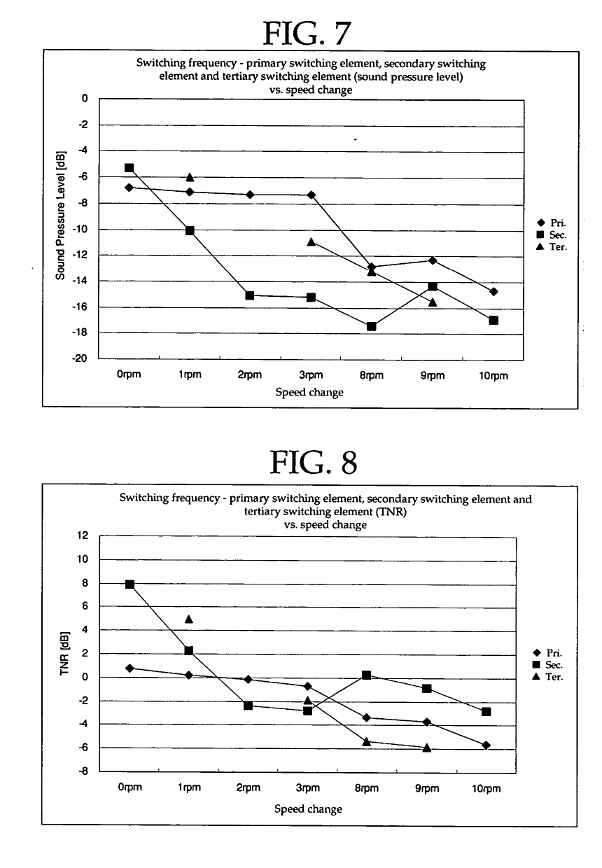

FIG. 7 is a graph showing a change in a sound pressure level (dB) when the speed of the spindle motor (or the magnetic disk connected to the spindle motor) of the magnetic disk apparatus is changed (increased) stepwise by ±1 rpm based on 5,400 rpm. FIG. 8 is a graph showing a change in the tone-to-noise ratio (TNR) (dB) when the speed of the spindle motor (or the magnetic disk connected to the spindle motor) of the magnetic disk apparatus is changed (increased) stepwise by ±1 rpm based on 5,400 rpm. Herein, the speeds of 1 rpm to 10 rpm on the abscissa of the graphs in FIG. 7 and FIG. 8 respectively denote ±1 rpm to ±10 rpm.

FIG. 8 evidently shows that varying the speed of the spindle motor (speed of the magnetic disk) may decrease the tone-to-noise ratio (TNR) of each of the primary switching element, the secondary switching element and the tertiary switching element. In this case, the speed of the spindle motor of 5,400 rpm, that is, “0 rpm” on the abscissa in FIG. 8, may allow the switching element with the highest tone-to-noise ratio (TNR) to become a main element of the uncomfortable noise. In FIG. 8, it is the secondary switching element that is the main element of the uncomfortable noise. Varying the speed of the spindle motor by ±3 rpm or more may effectively decrease the tone-to-noise ratio (TNR), and varying the speed of the spindle motor by ±8 rpm or more may prominently decrease the tone-to-noise ratio (TNR). On the abscissa in FIG. 8, the decrease in the tone-to-noise ratio (TNR) to less than when it is at the “0 rpm” may signify that the decreasing of the uncomfortable noise is effected. The more the uncomfortable noise is decreased in amount, the more prominently the decreasing is effected. In FIG. 7 and FIG. 8, the tertiary switching element at 0 rpm and 2 rpm does not show its peak, thereby is free from dot.

The present invention can solve the conventional issues. The present invention provides a switch drive motor apparatus and a high-performance magnetic disk apparatus incorporating therein the switch drive motor apparatus, which apparatuses can effectively control and decrease the prominent discrete tone which is uncomfortable and is attributable to the electromagnetic noise caused when a switching noise made through the switching of the phases for rotatably driving the motor (such as the spindle motor and the like of the hard disk drive and the like) is superimposed with a coil voltage. Moreover, the present invention provides the method of decreasing the electromagnetic noise of the switch drive motor apparatus and the method of decreasing the electromagnetic noise of the magnetic disk apparatus, which methods can effectively control and decrease the prominent discrete tone which is uncomfortable and is attributable to the electromagnetic noise.

The switch drive motor apparatus of the present invention can be preferably used as the motor such as the spindle motor and the like of the disk apparatuses including various magnetic disk apparatuses and various optical disk apparatuses. Hereinabove, the various magnetic disk apparatuses and the various optical disk apparatuses include a hard disk drive, a CD (compact disk) apparatus, an MD (mini disk) apparatus, an FD (flexible disk) apparatus, a DVD (digital video disk, digital versatile disk) apparatus, and the like.

The magnetic disk apparatus of the present invention can be preferably used as the hard disk drive, the FD (flexible disk) apparatus and the like.

The method of decreasing the electromagnetic noise of the switch drive motor of the present invention is preferable for effectively controlling and decreasing the prominent discrete tone which is uncomfortable and is attributable to the electromagnetic noise caused when a switching noise made through the switching of the phases for rotatably driving the motor (such as the spindle motor and the like of the disk apparatuses including various magnetic disk apparatuses and various optical apparatuses) is superimposed with a coil voltage. Hereinabove, the various magnetic disk apparatuses and the various optical disk apparatuses include a hard disk drive, a CD (compact disk) apparatus, an MD (mini disk) apparatus, an FD (flexible disk) apparatus, a DVD (digital video disk, digital versatile disk) apparatus, and the like.

The method of decreasing the electromagnetic noise of the magnetic disk apparatus of the present invention is preferable for effectively controlling and decreasing the prominent discrete tone which is uncomfortable and is attributable to the electromagnetic noise caused when a switching noise made through the switching of the phases for rotatably driving the motor (such as the spindle motor and the like of the magnetic disk apparatus including a hard disk drive, an FD (flexible disk) apparatus and the like) is superimposed with a coil voltage.

1. A switch drive motor apparatus, comprising:
a switch drive motor which is rotatable by making a sequential switching; and
a motor speed controller configured to drive the switch drive motor while varying a speed of the switch drive motor.

2. The switch drive motor apparatus according to claim 1, wherein the motor speed controller drives the switch drive motor by continuously varying the speed of the switch drive motor.

3. The switch drive motor apparatus according to claim 1, wherein the motor speed controller varies the speed of the switch drive motor with a variation width of 3 rpm or more.

4. The switch drive motor apparatus according to claim 1, wherein the motor speed controller varies the speed of the switch drive motor with a variation width of 8 rpm or more.

5. The switch drive motor apparatus according to claim 1, wherein the switch drive motor apparatus decreases, by 6 dB or more, a tone-to-noise ratio specified in International Organization for Standardization 7779 (1999-Aug.-01).

6. The switch drive motor apparatus according to claim 1, wherein the switch drive motor is substantially free from increasing a sound pressure.

7. The switch drive motor apparatus according to claim 1, wherein the switch drive motor is a spindle motor adapted to rotate a magnetic disk in a magnetic disk apparatus.

8. The switch drive motor apparatus according to claim 7, wherein,
when a magnetic head is away from on the magnetic disk, the motor speed controller varies the speed of the switch drive motor with a variation width of 3 rpm or more, and
when the magnetic head is on the magnetic disk, the motor speed controller is substantially free from varying the speed of the switch drive motor.

9. The switch drive motor apparatus according to claim 1, wherein the switch drive motor is operated at the speed of 4,000 rpm or more.

10. A magnetic disk apparatus, comprising:
a switch drive motor apparatus which comprises:
a switch drive motor which is rotatable by making a sequential switching; and
a motor speed controller configured to drive the switch drive motor while varying a speed of the switch drive motor.

11. A method of decreasing an electromagnetic noise of a switch drive motor apparatus, comprising:
driving the switch drive motor while varying a speed of the switch drive motor which is rotatable by making a sequential switching.

12. The method of decreasing the electromagnetic noise of the switch drive motor apparatus, according to claim 11, wherein the switch drive motor is driven while the speed of the switch drive motor is continuously varied.

13. The method of decreasing the electromagnetic noise of the switch drive motor apparatus, according to claim 11, wherein the speed of the switch drive motor is varied with a variation width of 3 rpm or more.

14. The method of decreasing the electromagnetic noise of the switch drive motor apparatus, according to claim 11, wherein the speed of the switch drive motor is varied with a variation width of 8 rpm or more.

15. The method of decreasing the electromagnetic noise of the switch drive motor apparatus, according to claim 11, wherein a tone-to-noise ratio specified in International Organization for Standardization 7779 (1999-Aug.-01) is decreased by 6 dB or more.

16. The method of decreasing the electromagnetic noise of the switch drive motor apparatus, according to claim 11, wherein a sound pressure is free from being increased.

17. The method of decreasing the electromagnetic noise of the switch drive motor apparatus, according to claim 11, wherein the switch drive motor is a spindle motor adapted to rotate a magnetic disk in a magnetic disk apparatus.

18. The method of decreasing the electromagnetic noise of the switch drive motor apparatus according to claim 17, wherein,
when a magnetic head is away from on the magnetic disk, the speed of the switch drive motor is varied with a variation width of 3 rpm or more, and
when the magnetic head is on the magnetic disk, the speed of the switch drive motor is free from being varied.

19. The method of decreasing the electromagnetic noise of the switch drive motor apparatus, according to claim 11, wherein the switch drive motor is operated at the speed of 4,000 rpm or more.

20. A method of decreasing an electromagnetic noise of a magnetic disk apparatus which has a switch drive motor apparatus, the method comprising:
driving a switch drive motor while varying a speed of the switch drive motor which is rotatable by making a sequential switching.
